(19) United States
(12) Patent Application Publication
(10) Pub. No.: US 2013/0265768 A1
(43) Pub. Date: Oct. 10, 2013

(54) ILLUMINATING MODULE FOR A MICRO PROJECTING DEVICE

(71) Applicant: MEGAFORCE COMPANY LIMITED, New Taipei City (TW)

(72) Inventors: Jung-Shu Wang, New Taipei (TW); Wen-Chieh Wu, New Taipei City (TW); Pao-Tang Su, New Taipei City (TW)

(73) Assignee: MEGAFORCE COMPANY LIMITED, New Taipei City (TW)

(21) Appl. No.: 13/846,911

(22) Filed: Mar. 18, 2013

(30) Foreign Application Priority Data
Apr. 6, 2012 (TW) 101206215

(51) Int. Cl. F21V 21/30

(52) U.S. Cl. CPC F21V 21/30
USPC 362/287; 362/372

(57) ABSTRACT

An illuminating module includes a casing, a sleeve forming a positioning device to contact with the casing; and a light source one end of which is extended into the sleeve, wherein the positioning device of the sleeve is non-fixedly contacted with the casing so as to adjust the sleeve to a desired location and direction in the casing. With the positioning device, the assembly process of the illuminating module becomes more easily to be accomplished and ensures the optical quality.

### BACKGROUND OF THE INVENTION

1. Field of the Invention

This invention is related to an illuminating module, and more particular to an illuminating module used for a micro projecting device. The illuminating module equipped with a positioning device is able to be easily adjusted to an ideal, precise location during the assembly process of the illuminating module.

2. Description of Related Art

Conventional micro projecting device generally includes a light source module, a light guiding module and an optical mechanism. The light beam emitted by the light source module passes through the integrator rod and a condenser lens of the light guiding module so as to form an image so projected to the screen via the projector lens. Conventionally, the light source module and the light guiding module are fixed by the optical mechanism of a micro projecting device with the help of adhesive glue. However, during the assembly process of the micro projecting device, it is necessary to adjust the position and the direction of the light source module and the light guiding module before the adhesive glue entirely solidified so as to accomplish a correct, precise optical path in the micro projecting device. In view of the experience of the assembly process with the adhesive glue, the light source module is difficult to be fixed in the idea position, because the adhesive glue is easily affected by temperature, and the light source module cannot be positioned well in the micro projecting device due to the bad control ability and thus the projected image on the screen is poor.

### SUMMARY OF THE INVENTION

The primary objective of the present invention is to provide an illuminating module having a positioning device which enhances the adjustability during the assembly process.

In order to accomplish the aforementioned objectives, the illuminating module constructed in accordance with the present invention has a casing; a sleeve forming a positioning device on the outer surface of the sleeve to contact with the casing; and a light source one end of which is extended into the sleeve, wherein the positioning device of the sleeve is non-fixedly contacted with the casing so as to move the sleeve to a desired location and direction in the casing.

Thus, it is benefit to the assembly process of the illuminating module because the mechanism of the positioning device provides a good control ability to adjust the position of each of the optical elements.

### BRIEF DESCRIPTION OF THE DRAWINGS

The invention, as well as its many advantages, may be further understood by the following detailed description and accompanying drawings.

FIG. 1 is a exploded perspective view of the illuminating module constructed in accordance with the present invention;

FIG. 2 is a cross section view of the illuminating module from an angle different from that of FIG. 1;

FIG. 3a is a perspective view of the assembled illuminating module showing the first movement of the sleeve of the of the present invention;

FIG. 3b is a perspective view of the assembled illuminating module showing the second movement of the sleeve of the of the present invention;

FIG. 3c is a perspective view of the assembled illuminating module showing the third movement of the sleeve of the of the present invention; and

FIG. 4 is an exploded perspective view of an application of the illuminating module of the present invention.

### DETAILED DESCRIPTION OF THE INVENTION

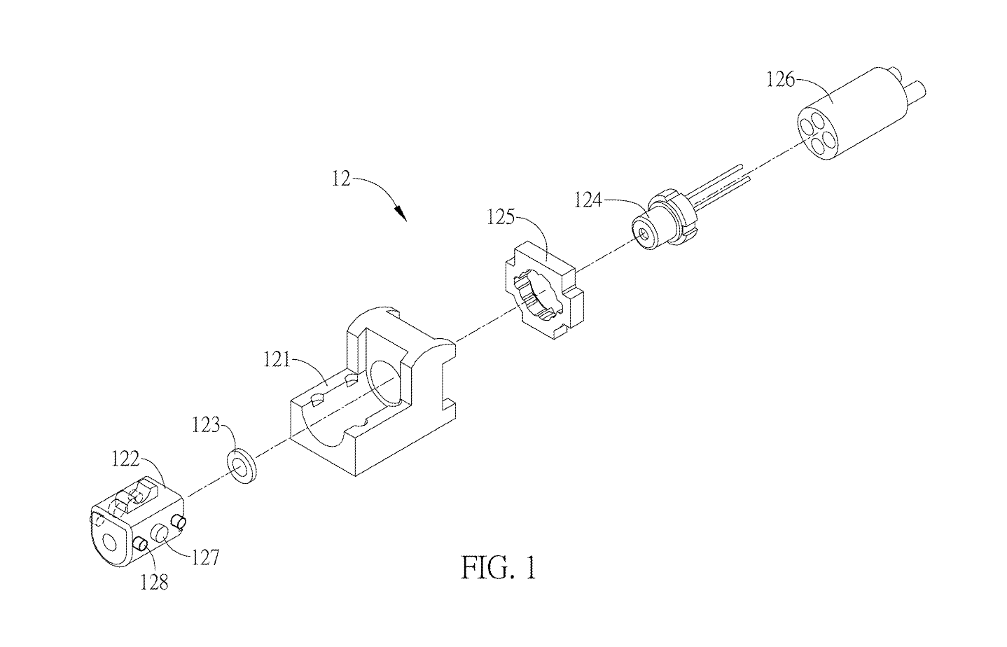

With reference to FIG. 1, it is to be noted that the illuminating module 12 is constructed in accordance with the preferred embodiment of the present invention.

Referring to FIG. 1, each of the illuminating modules 12 constructed in accordance with the preferred embodiment of the present invention has a casing 121, a sleeve 122 inserted into the casing 121, a collimate lens 123, a light source 124 (such as laser diode) connected to the collimate lens 123, a connector 126 having the light source 124 extended therein and an axial adjusting element 125 mounted around the light source 124 to adjust the light source 124 axially. It is noted that the sleeve 122 has a pair of protrusions 127 formed on two opposite sidewalls of the sleeve 122, and two bosses 128 are formed on the each of the opposite sidewalls adjacent to the protrusions 127. It is to be noted that the diameter of each of the bosses 128 is smaller than the diameter of each of the protrusions 127.

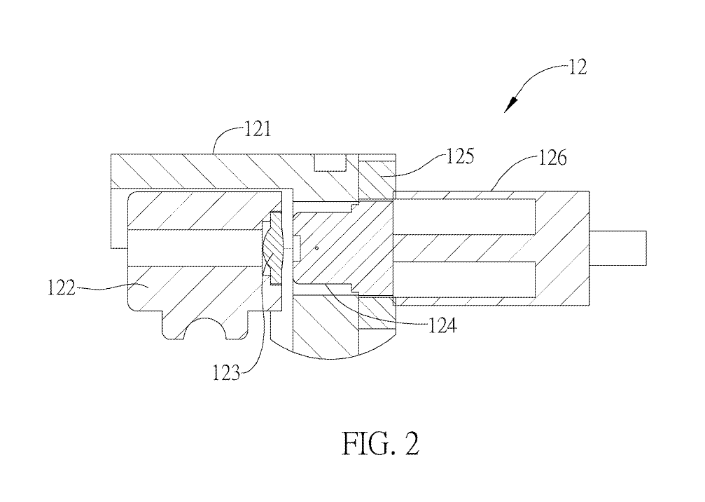

With reference to FIG. 2, for further understanding of how the illuminating module 12 of the preferred embodiment of the present invention is assembled and still using FIG. 1 for reference, it is noted that after the illuminating module 12 is assembled, the sleeve 122 is extended into the casing 121. After one end of the light source 124 is extended into the casing 121, the light source 124 is connected to one side of the collimating lens 123. That is, the collimating lens 123 is sandwiched between the sleeve 122 and the light source 124. Still, after the other end of the light source 124 is extended into the connector 126, the axial adjusting element 125 is mounted around the light source 124 so as to adjust the light source 124 axially.

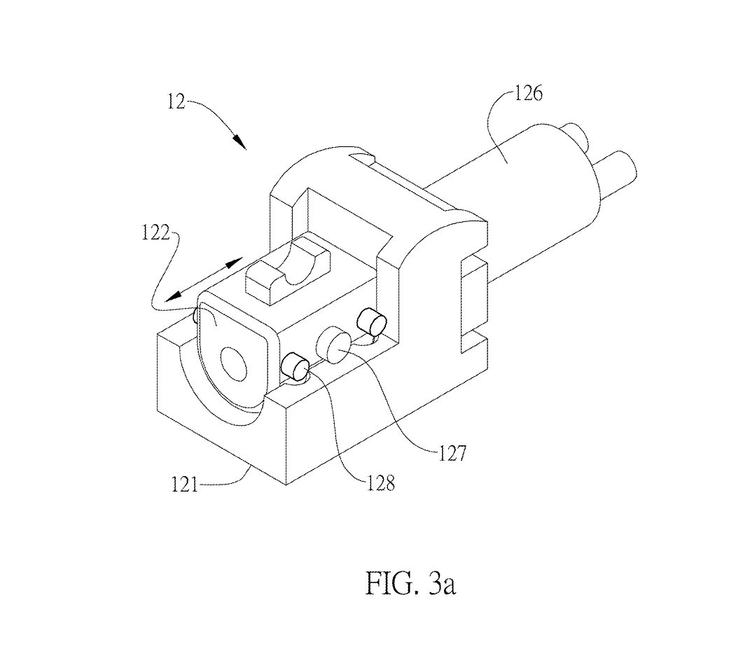

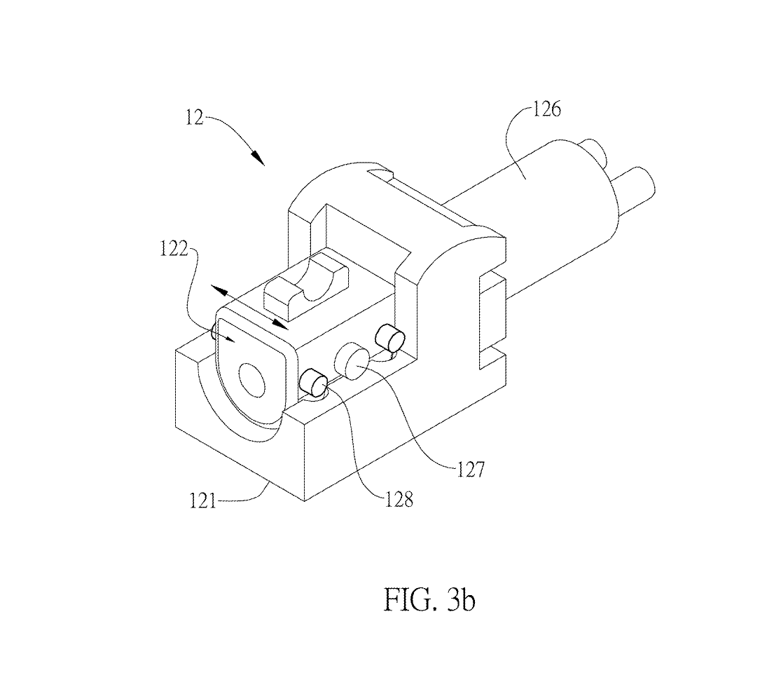

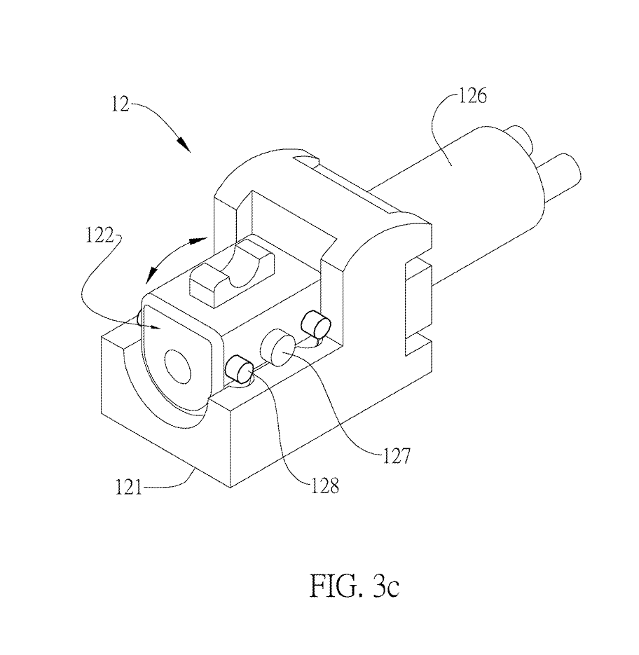

Taking FIG. 3a-3c to further understanding the function of the protrusions 127 and the bosses 128. During the assembly process of the illuminating module 12 of the preferred embodiment of the present invention, the sleeve 122 is inserted into the casing 121, a gap (not shown) defined between the sleeve 122 and the casing 121 is capable of filling the adhesive glue to firm the combination therebetween. Before the adhesive glue becomes solidified, the relative position between the casing 121 and the sleeve 122 is adjustable by positioning the protrusions 127 and bosses 128 to the idea location. Because the protrusions 127 and the bosses 128 of the sleeve 122 are respectively leaned on the horizontal faces of the casing 121, the sleeve 122 is able to be moved horizontally and pivotally in the casing 121 to a desired position and direction.

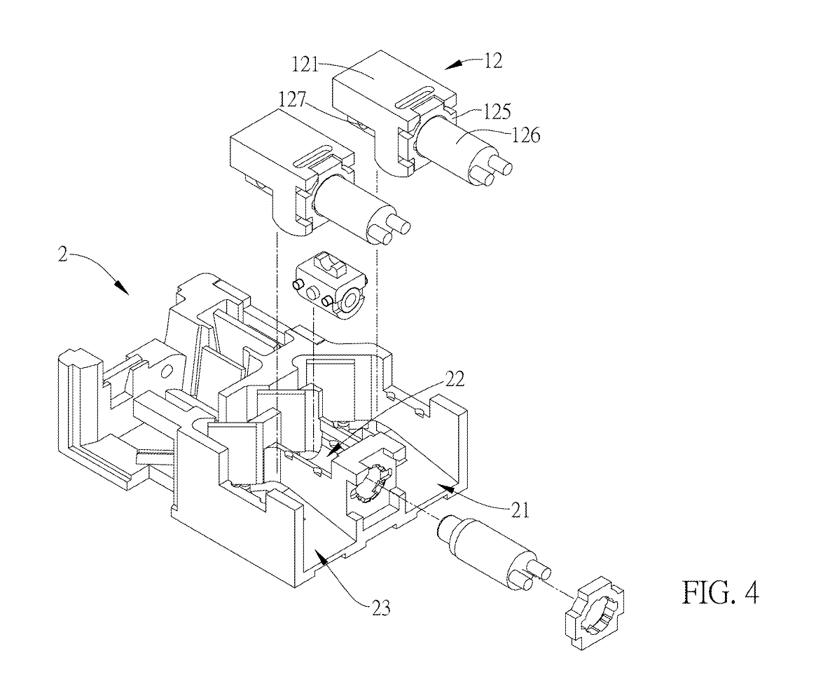

With reference to FIG. 4, a base 2 is provided to receive more than one illuminating module 12 therein to create an application such as multiple optical projecting device, where the base 2 has multiple compartments, namely, 21, 22, 23 to respectively correspond to the illuminating modules 12 . Therefore, a good projection effect is easily achieved.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An illuminating module comprises:
a casing;
a sleeve forming a positioning device on the outer surface of the sleeve to contact with the casing; and
a light source one end of which is extended into the sleeve,
wherein the positioning device of the sleeve is non-fixedly contacted with the casing so as to adjust the sleeve to a desired location and direction in the casing.

2. The illuminating module as claimed in claim 1 further comprising an axial adjusting element mounted around the connector to adjust the illuminating element axially.

3. The illuminating module as claimed in claim 1 further comprising a collimating lens sandwiched between the sleeve and the light source.

4. The illuminating module as claimed in claim 1, wherein the positioning device comprises a pair of protrusions formed on the outside surface of the sleeve, and two bosses are formed adjacently to each of the protrusions.

5. The illuminating module as claimed in claim 2 further comprising a collimating lens sandwiched between the sleeve and the light source.

6. The illuminating module as claimed in claim 3, wherein the positioning device comprises a pair of protrusions formed on the outside surface of the sleeve, and two bosses are formed adjacently to each of the protrusions.

7. The illuminating module as claimed in claim 4 further comprising an axial adjusting element mounted around the connector to adjust the illuminating element axially.

8. The illuminating module as claimed in claim 5, wherein the positioning device comprises a pair of protrusions formed on the outside surface of the sleeve, and two bosses are formed adjacently to each of the protrusions.
